(19) United States
(12) Patent Application Publication
(10) Pub. No.: US 2009/0291831 A1
(43) Pub. Date: Nov. 26, 2009

(54) HONEYCOMB STRUCTURE

(75) Inventors: Kazushige OHNO, Ibi-Gun (JP); Masafumi Kunieda, Ibi-Gun (JP); Takahiko Ido, Ibi-Gun (JP)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 12/359,969

(22) Filed: Jan. 26, 2009

(30) Foreign Application Priority Data
May 20, 2008 (JP) PCT/JP2008/059274

(51) Int. Cl. B01J 29/06; B01J 29/40; B01J 29/072

(52) U.S. Cl. 502/65; 502/64; 502/71; 502/66; 502/68

(57) ABSTRACT

A honeycomb structure includes at least one honeycomb unit. The honeycomb unit includes plural cell walls to define plural cells, about 61 to about 70 mass % of zeolite, about 15 to about 25 mass % of an inorganic fiber, and about 10 to about 20 mass % of alumina other than alumina included in the zeolite and the inorganic fiber. The honeycomb unit has an opening ratio (%) of about 57% or more. The opening ratio is equal to or less than y shown in a formula of y=0.55x+30 when a content x (mass %) of the zeolite included in the honeycomb unit is less than about 66 mass %. The opening ratio is equal to or less than y shown in a formula of y 32 −0.25x+82.8 when the content x (mass %) is about 66 mass % or more.

### CROSS-REFERENCE TO RELATED APPLICATION

The present application claims priority under 35 U.S.C §119 to International Application No. PCT/JP2008/059274, filed May 20, 2008, the entire contents of which are incorporated herein by reference.

### BACKGROUND OF THE INVENTION

1. Field of the Invention

The present invention relates to a honeycomb structure.

2. Description of the Related Art

Conventionally, various techniques have been developed to convert vehicle exhaust gas, however, sufficient countermeasures have not been taken for the increasing traffic. Emission restrictions will become tighter not only in Japan but all over the world. In particular, a restriction of NOx in diesel exhaust gas is becoming very strict. Moreover, a conventional method to reduce NOx by controlling an engine combustion system is becoming insufficient. As a diesel NOx converting system for such problems, there is a NOx reduction system called an SCR (Selective Catalytic Reduction) system using ammonia as a reducing agent.

As a catalyst carrier used in such a system, a honeycomb structure is widely known. A honeycomb structure disclosed in International Publication No. 2005/063653 is formed of a honeycomb unit, which is formed by mixing an inorganic binder and an inorganic fiber in γ alumina, ceria, zirconia, zeolite, or the like to form a mixture, and molding and firing the mixture formed in a honeycomb shape.

Japanese Patent No. 2675321 discloses a NOx converting method to reduce NOx in diesel exhaust gas by ammonia, using a honeycomb catalyst having through-holes (cells) with an equivalent diameter of 1.5 to 5 mm, a cell wall with a thickness of 0.3 to 0.9 mm, and a specific pore area with a pore volume of 40% or more of the total pore volume. The entire contents of International Publication No. 2005/063653 and Japanese Patent No. 2675321 are incorporated herein by reference.

### SUMMARY OF THE INVENTION

According to one aspect of the present invention, a honeycomb structure includes at least one honeycomb unit. The at least one honeycomb unit includes plural cell walls extending from one end face to another end face in a longitudinal direction of the honeycomb structure to define plural cells. The at least one honeycomb unit includes about 61 mass % to about 70 mass % of zeolite, about 15 mass % to about 25 mass % of an inorganic fiber, and about 10 mass % to about 20 mass % of alumina other than alumina included in the zeolite and the inorganic fiber. The at least one honeycomb unit has an opening ratio (%) of about 57% or more. The opening ratio is equal to or less than y shown in a following formula (1) when a content x (mass %) of the zeolite included in the at least one honeycomb unit is less than about 66 mass %.

y=0.55x+30 (1)

The opening ratio is equal to or less than y shown in a following formula (2) when the content x (mass %) of the zeolite included in the at least one honeycomb unit is about 66 mass % or more.

y=−0.25x+82.8 (2)

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a perspective view of a honeycomb structure of an embodiment of the present invention formed of plural honeycomb units and FIG. 1B is a perspective view of a honeycomb structure of an embodiment of the present invention formed of one honeycomb unit;

FIG. 2 is a perspective view of a honeycomb unit which forms the honeycomb structure shown in FIG. 1A; and

FIG. 3 is a graph showing a relationship between the content x of zeolite and the opening ratio y of honeycomb structures of examples and comparison examples.

### DETAILED DESCRIPTION OF THE PREFERRED EMBODIMENTS

Embodiments will now be described with reference to the accompanying drawings, wherein like reference numerals designate corresponding or identical elements throughout the various drawings.

In general, a NOx converting catalyst for vehicle exhaust gas using a honeycomb structure is required to be small in size, lightweight, have enough strength against vibration and a pressure generated when the car is running, and have a small flow resistance of the exhaust gas and a sufficient NOx converting performance.

Therefore, the present inventors researched how contents of zeolite, an inorganic fiber, and alumina which are used as materials for a honeycomb unit in a honeycomb structure, a contained amount of zeolite, an opening ratio, and a cell density influence the strength and a catalytic performance of the honeycomb unit as a basic unit of the honeycomb structure. To improve the strength of the honeycomb unit, the content of zeolite is reduced, the contents of the inorganic fiber and alumina are increased, and the opening ratio is set small. To improve the catalytic performance, on the other hand, it is considered that the content of zeolite is required to be increased and the opening ratio is required to be small. Further, to reduce the flow resistance of the honeycomb structure with respect to exhaust gas, it is considered that the opening ratio is required to be large. Furthermore, to form a small and lightweight honeycomb unit, a thickness of the cell wall is required to be thin for the ease of the exhaust gas entering in the cell wall so that the whole cell wall including the surface can be effectively used as a catalyst. The inventors researched a relationship of the aforementioned parameters, in particular a relationship between the content of zeolite and the opening ratio, and discovered that the honeycomb structure of the present invention is favorable as a catalyst for a use in a vehicle, for converting NOx in diesel exhaust gas.

When forming a honeycomb unit to be used in the honeycomb structure as disclosed in International Publication No. 2005/063653 pamphlet by molding and firing a material including zeolite as a main raw material, sufficient strength of the honeycomb unit cannot be kept in some cases when, in particular, zeolite is increased. Therefore, there is a problem in some cases that the honeycomb structure as disclosed in International Publication No. 2005/063653 cannot keep the performance as the NOx converting catalyst for the exhaust gas in the SCR system.

In the honeycomb catalyst as disclosed in Japanese Patent No. 2675321, a cell wall is as thick as 0.3 mm or more to keep the strength. With a thicker cell wall, however, a NOx gas in exhaust gas does not penetrate deep enough into the cell wall. Since an exhaust gas converting reaction occurs only on a surface of the cell wall, there is a case that the whole cell wall cannot be effectively used. In general, when a cell wall is thick and through-holes (cells) have a small equivalent diameter, an area occupied by the through-holes (cells) becomes small. When using this honeycomb catalyst for converting exhaust gas, there is a tendency that a pressure loss of the exhaust gas through the honeycomb structure increases. Therefore, a larger honeycomb catalyst with a larger opening ratio is considered to be required to obtain desired flow characteristics and converting performance for the same vehicle exhaust gas. Since a NOx converting catalyst for the vehicle exhaust gas is required to be lightweight and downsized, there is a problem in employing such a honeycomb catalyst as the NOx converting catalyst.

According to the embodiment of the present invention, a honeycomb structure having superior converting performance as a NOx converting catalyst for vehicle exhaust gas, enough strength for a use in a vehicle, and a small flow resistance of the exhaust gas can be formed.

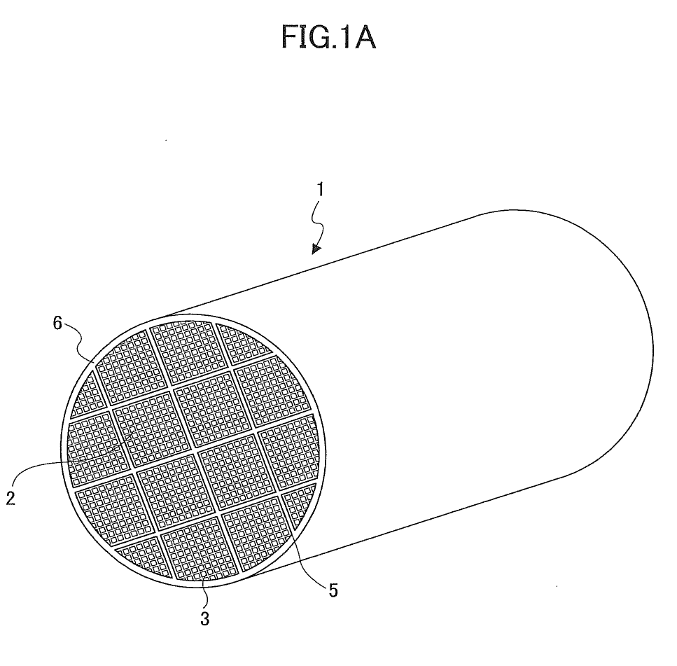

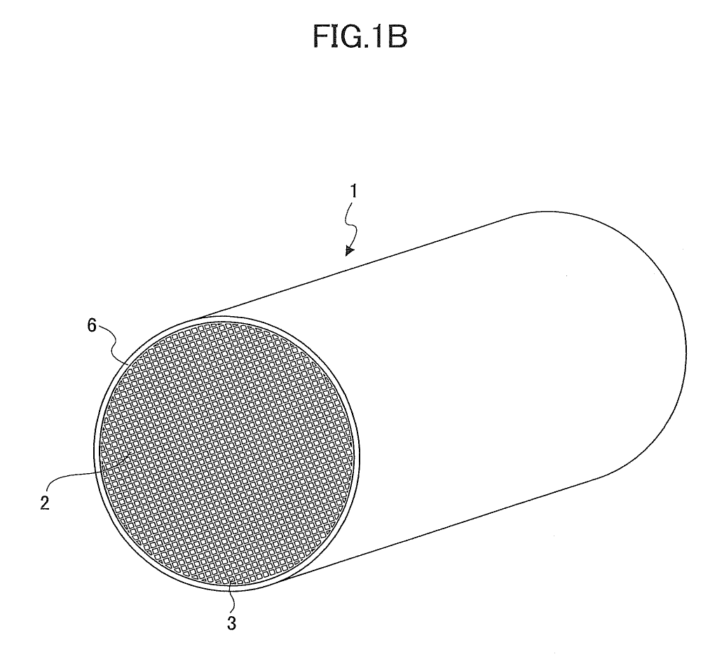

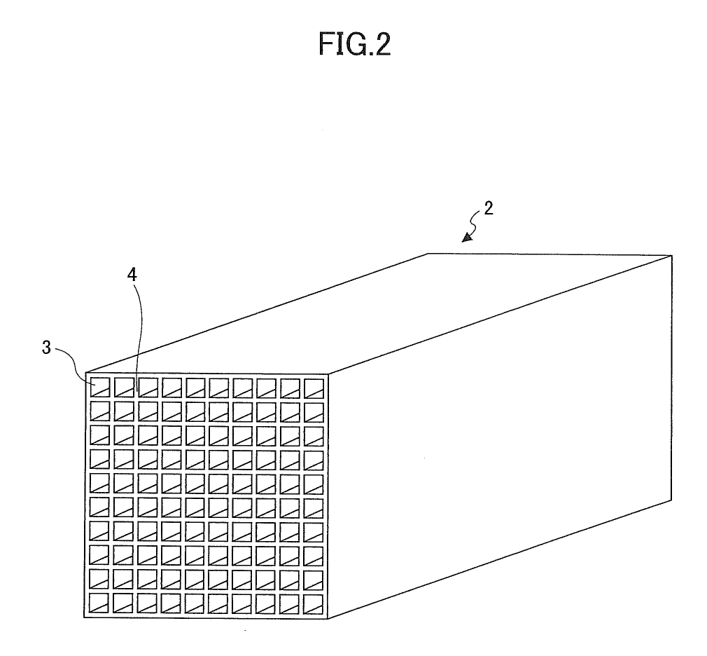

The honeycomb structure of the embodiment of the present invention includes one or plural honeycomb units formed of a fired body in a shape in which plural cells extending from one end face to the other end face of the honeycomb structure in a longitudinal direction are separated by cell walls. FIG. 1A is a perspective view showing an example of the honeycomb structure. In a honeycomb structure 1 shown in FIG. 1A, plural honeycomb units 2 are bonded to each other with an adhesive 5 and arranged together. Each honeycomb unit 2 is formed so that cells 3 are aligned in parallel to each other. It is preferable that a side surface (a surface where the cells are not open) of the honeycomb structure 1 be covered with a coating material layer 6 formed of a coating layer to keep the strength of the honeycomb structure. As shown in the perspective view of FIG. 2, the honeycomb unit 2 forming the honeycomb structure 1 includes plural cells 3 extending in the longitudinal direction. Cell walls 4 separate the cells 3 in the honeycomb unit 2.

The honeycomb unit includes zeolite, an inorganic fiber, and alumina. The honeycomb unit may further include other inorganic particles and/or an inorganic binder. The honeycomb unit includes about 61 mass % to about 70 mass % of zeolite, about 15 mass % to about 25 mass % of the inorganic fiber, and about 10 mass % to about 20 mass % of alumina which is not included in the zeolite and the inorganic fiber. In the honeycomb unit of the embodiment of the present invention, zeolite functions to convert NOx in the vehicle exhaust gas. Therefore, when zeolite included in the honeycomb unit becomes equal to or more than about 61 mass %, a NOx converting performance of the honeycomb unit does not tend to be reduced. When the honeycomb unit includes equal to or less than about 70 mass % of zeolite, it becomes easier to maintain the strength required for the honeycomb unit used as a NOx converting catalyst for vehicle exhaust gas.

In the honeycomb unit of the honeycomb structure of the embodiment of the present invention, an opening ratio as an area ratio of apertures to a cross-section vertical to the longitudinal direction of the cells (a face where plural cells are open, which hereinafter corresponds to a cross-section of the honeycomb unit) is about 57% or more. It is preferable that the opening ratio of the honeycomb unit be about 57% or more so as not to increase the pressure loss of the exhaust gas to be converted.

When the content of zeolite in the honeycomb unit of the honeycomb structure of the embodiment of the present invention is x (mass %) and the content x of zeolite is less than about 66 mass %, an opening ratio (%) of the honeycomb unit is a y value expressed by the following formula (1) or less.

y=0.55x+30 (1)

When the content x (mass %) of zeolite is about 66 mass % ormore, the opening ratio (%) is a yvalue expressed by the following formula (2) or less.

y=−0.25x+82.8 (2)

The formulas (1) and (2) are experimentally obtained to keep the preferable NOx converting ratio and/or the strength of the honeycomb unit. When the opening ratio becomes greater than the y value in the formula (1), the NOx converting ratio and/or the strength of the honeycomb unit tend to be reduced even when the content of zeolite is about 61 mass % or more.

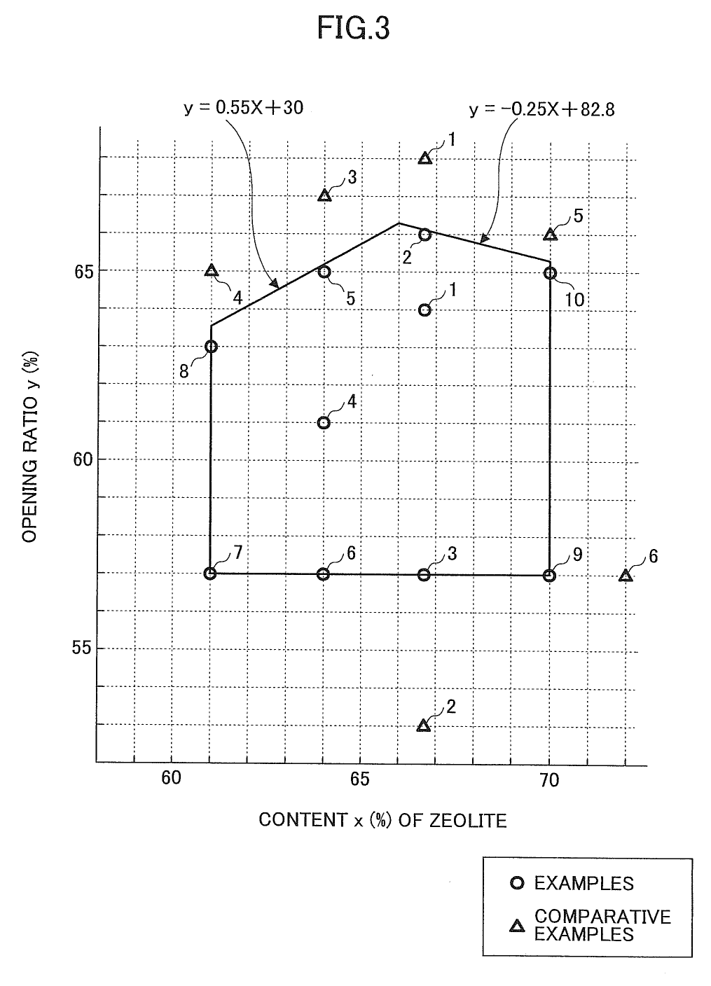

In these two formulas, the y values are both 66.3% when the content of zeolite is 66 mass % as shown in the graph of FIG. 3. That is, as shown in FIG. 3, it is considered that the content x (mass %) of zeolite and the opening ratio y (%) of the honeycomb unit of the embodiment of the present invention are required to be within an area surrounded by five lines of x=61, x=70, y=57, y=0.55x+30 (formula (1)), and y=−0.25x+82.8 (formula (2)).

It is preferable that the cell wall of the honeycomb unit in the honeycomb structure of the embodiment of the present invention have a porosity of about 25% to about 40%. With the porosity of equal to or more than about 25%, the exhaust gas is facilitated to penetrate deep enough into the cell wall. Thus, the NOx converting ratio does not tend to be insufficient. Moreover, when the porosity of the honeycomb unit becomes equal to or less than about 40%, the strength of the cell wall in the honeycomb unit does not tend to be reduced.

It is preferable that the honeycomb unit in the honeycomb structure of the embodiment of the present invention have a cell density of the honeycomb unit cross-section of about 39 cells/cm² to about 124 cells/cm², or more preferably about 62 cells/cm²to about 124 cells/cm². When the cell density is equal to or more than about 39 cells/cm², the thickness of the cell wall does not become too thick due to the opening ratio, which facilitates the exhaust gas to be penetrated deep enough into the cell wall, and the NOx converting performance does not tend to be reduced. When the cell density is equal to or less than about 124 cells/cm², an area per cell does not tend to be small. As a result, the pressure loss does not tend to be increased.

In the honeycomb unit in the honeycomb structure of the embodiment of the present invention, it is preferable that the content of zeolite per apparent unit volume be about 230 g/L or more, and more preferably about 245 g/L to about 270 g/L. When the content of zeolite per apparent unit volume in the honeycomb unit is equal to or more than about 230 g/L, the NOx converting performance does not tend to be degraded. Moreover, when the content of zeolite per apparent unit volume in the honeycomb unit is equal to or less than about 270 g/L, it becomes easier to maintain the strength of the honeycomb unit and also of the honeycomb structure.

The thickness of the cell wall of the honeycomb unit of the embodiment of the present invention is preferably about 0.15 mm to about 0.35 mm, or more preferably about 0.15 mm to about 0.28 mm. When the thickness of the cell wall is equal to or more than about 0.15 mm, it becomes easier to maintain the strength of the honeycomb unit. Moreover, when the thickness of the cell wall is equal to or less than about 0.35 mm, the exhaust gas is facilitated to penetrate deep enough into the cell wall. As a result, the NOx converting performance does not tend to be degraded.

Hereinafter, a specific honeycomb structure of the embodiment of the present invention is described.

(Honeycomb Unit)

A honeycomb unit of the honeycomb structure of the embodiment of the present invention has what is called a honeycomb structure having plural cells 3 serving as parallel through-holes as shown in FIG. 2. A cross-sectional shape of the cell 3 in the honeycomb unit is not particularly limited. FIG. 2 shows the cell 3 having a square cross-sectional shape, however, the cell 3 may have a substantially triangular cross-sectional shape, a substantially hexagonal cross-sectional shape, a circular cross-sectional shape, a combination of square and octagonal cross-sectional shapes, or the like.

The honeycomb unit includes zeolite, an inorganic fiber, and alumina which is not included in zeolite and the inorganic fiber.

(Zeolite)

Zeolite in the honeycomb unit is formed of zeolite particles bonded by inorganic binders or the like. As zeolite, for example, β-type zeolite, Y-type zeolite, ferrierite, ZSM-5 type zeolite, mordenite, faujasite, zeolite A, zeolite L and the like is used. These zeolites may be used alone or in combination.

As zeolite, it is preferable that a mole ratio of silica to alumina (silica/alumina ratio) be about 30 to about 50.

Moreover, it is preferable that ion-exchanged zeolite, which is the aforementioned zeolite with exchanged ions, be included. Zeolite with ions exchanged in advance may be used to form the honeycomb unit, or ions of zeolite may be exchanged after forming the honeycomb unit. As ion-exchanged zeolite, zeolite with exchanged ions of at least one of metal species: Fe, Cu, Ni, Co, Zn, Mn, Ti, Ag, and V is preferably used. These ion-exchanged zeolites may include one or plural metal species. As ion-exchanged zeolite, it is preferable that Fe or Cu ion-exchanged zeolite, in particular Fe ion-exchanged zeolite be included.

The content (composition rate) of zeolite in the honeycomb unit is about 61 mass % to about 70 mass % as described above. Further, the content of zeolite per apparent unit volume of the honeycomb unit is preferably about 230 g/L, and more preferably about 245 g/L to about 270 g/L. As zeolite functions to convert NOx, it is preferable that more zeolite be included in the honeycomb unit. However, when only the content of zeolite is increased, contents of other substances (for example, the inorganic fiber and the inorganic binder) are required to be reduced. As a result, the strength of the honeycomb unit tends to be degraded. Moreover, when the opening ratio of the honeycomb unit is reduced too small to increase the content of zeolite, the flow resistance of the exhaust gas may be too high in the NOx converting reaction.

It is preferable that zeolite include secondary particles with an average particle diameter of about 0.5 μm to about 10 μm. The average particle diameter of the secondary particle may be measured by using the zeolite particles serving as a raw material before firing, which form the secondary particles.

(Inorganic Fiber)

In the honeycomb structure of the embodiment of the present invention, the honeycomb unit includes about 15 mass % to about 25 mass % of inorganic fiber. The inorganic fiber included in the honeycomb unit is not particularly limited, but one or more inorganic fibers selected from an alumina fiber, a silica fiber, a silicon carbide fiber, a silica alumina fiber, a glass fiber, a potassium titanate fiber, and an aluminum borate fiber is used. These inorganic fibers may be mixed with zeolite or an inorganic binder in a raw material state and used to mold and fire a honeycomb unit. The inorganic fiber functions to improve the strength of the honeycomb unit. As the inorganic fiber, a short fiber such as a whisker may be used as well as a long fiber.

When the honeycomb unit includes equal to or more than about 15 mass % of the inorganic fiber, it becomes easier to sufficiently improve the strength of the honeycomb unit. When the honeycomb unit includes equal to or less than about 25 mass % of the inorganic fiber, the contents of other substances such as zeolite do not tend to be reduced. As a result, the NOx converting performance of the honeycomb unit does not tend to be degraded.

The inorganic fiber is an inorganic material having a large aspect ratio (fiber length/fiber diameter), which is particularly effective in improving a bending strength. The aspect ratio of the inorganic fiber is preferably about 2 to about 1000, or more preferably about 5 to about 800, and further more preferably about 10 to about 500. When the aspect ratio of the inorganic fiber is equal to or more than about 2, improvement of the strength of the honeycomb unit does not tend to be little. When the aspect ratio of the inorganic fiber is equal to or less than about 1000, a molding die is not easily clogged when molding the honeycomb unit. As a result, a molding property does not tend to be degraded. Further, the inorganic fibers are not easily broken in the case of molding such as extrusion molding. In this case, lengths of the inorganic fibers do not tend to vary and the strength of the honeycomb unit does not tend to be reduced. In the case where the aspect ratios of the inorganic fibers are distributed, an average value is to be employed.

(Alumina)

In the honeycomb structure of the embodiment of the present invention, the honeycomb unit includes about 10 mass % to about 20 mass % of alumina other than alumina included in the zeolite and the inorganic fiber. Such alumina in the honeycomb unit is derived from an inorganic binder such as alumina sol added as a binder in some cases. Moreover, such alumina is derived from an alumina particle or the like added as a raw material in some cases. Alumina used in the embodiment of the present invention may be any alumina other than alumina included in zeolite or the inorganic fiber, however, it is preferable that alumina derived from alumina sol (alumina included in alumina sol) be used. Alumina is considered to have an effect to strengthen bonds between the particles. When alumina included in the honeycomb unit is equal to or more than about 10 mass %, the strength of the honeycomb unit does not tend to be reduced. When alumina included in the honeycomb unit is equal to or less than about 20 mass %, the relative contents of zeolite and the inorganic fiber do not tend to be reduced. Thus, the NOx converting performance and the strength of the honeycomb unit do not tend to be degraded.

(Inorganic Binder)

In the honeycomb structure of the embodiment of the present invention, a honeycomb unit may include an inorganic binder. As the honeycomb unit is a fired body, moisture or the like in the inorganic binder is evaporated and only a solid content is left in the honeycomb unit. In this specification, an inorganic binder in the honeycomb unit is this solid content in the inorganic binder. As the inorganic binder in a raw material state, it is normally preferable to use alumina sol which can be used as the alumina source as well. As other inorganic binders, for example, there are inorganic sol, clay-type binder, and the like. As inorganic sol, for example, there are silica sol, titania sol, sepiolite sol, attapulgite sol, liquid glass, and the like. As the clay-type binder, for example, there are white clay, kaolin, montmorillonite, plural chain structure type clay (sepiolite and attapulgite), and the like. These inorganic sol and clay type binders may be used alone, in combination, or in combination with alumina sol.

(Inorganic particle)

The honeycomb unit of the embodiment of the present invention may include an alumina particle in a raw material state as an alumina component. As the alumina particle, it is preferable to use γ alumina or boehmite. The alumina particle is considered to improve the strength of the honeycomb unit.

The honeycomb unit of the embodiment of the invention may include an inorganic particle other than an alumina particle and a zeolite particle. In the honeycomb structure of the embodiment of the present invention, an inorganic particle other than the alumina particle and the zeolite particle, which is included in the honeycomb unit, is not particularly limited. For example, silica, zirconia, titania, ceria, mullite, and these precursors can be used. One or more kinds of inorganic particles may be included with the alumina particle.

An inorganic particle such as an alumina particle, which is used in the honeycomb structure of the embodiment of the present invention, has a hydroxyl group in a raw material state before firing. As most of inorganic compound particles for industrial use do, a raw material inorganic particle in the honeycomb structure of the embodiment of the present invention before firing and a raw material zeolite particle have a hydroxyl group. This hydroxyl group is considered to cause a dehydration condensation reaction and enhance bonds between the particles when firing the honeycomb unit. An alumina particle such as γ alumina and boehmite, in particular, is considered to form a strong bond by a dehydration condensation reaction that occurs when firing the honeycomb unit.

In the honeycomb structure of the embodiment of the present invention, it is preferable that the inorganic particle other than zeolite, which is used as a raw material, have a secondary particle with an average particle diameter equal to or smaller than an average particle diameter of a secondary particle of zeolite. In particular, it is preferable that the average particle diameter of the inorganic particle be about 1/10 to about 1/1 of the average particle diameter of zeolite. In this manner, enhancement of the strength of the honeycomb unit is facilitated by a bonding force of inorganic particles with a small average particle diameter.

(Catalytic Component)

The cell wall of the honeycomb unit in the honeycomb structure of the embodiment of the present invention may further carry a catalytic component. The catalytic component is not particularly limited, but a noble metal, an alkali metal compound, an alkali earth metal compound, and the like may be used. As the noble metal, for example, one or more of platinum, palladium, and rhodium is suggested. As the alkali metal compound, one or more compound of potassium, sodium, and the like is suggested. As the alkali earth metal, for example, a compound such as barium is suggested.

(Manufacture of Honeycomb Unit)

An example of a method for manufacturing a honeycomb unit in the honeycomb structure of the embodiment of the present invention is described. First, a raw material paste including the aforementioned inorganic binder such as zeolite and alumina sol and inorganic fiber at the predetermined ratios is manufactured, which is formed into a honeycomb unit molded body by extrusion molding or the like. In addition, an inorganic particle including an alumina particle, an organic binder, a pore-forming material, a disperse medium, a forming aid, and the like may be provided to the raw material paste. The organic binder is not particularly limited, but one or more organic binders selected from methylcellulose, carboxymethyl cellulose, hydroxyethyl cellulose, polyethylene glycol, a phenol resin, an epoxy resin, and the like is suggested. The organic binder is preferably mixed with the raw material paste in a ratio of about 1 part to about 10 parts by weight to 100 parts by total weight of a solid content of the raw material. As the pore-forming material, resin powder of an acrylic acid-based resin, a polyolefin-based resin, a polystyrene-based resin, a polyester-based resin, and the like can be used. The organic binder and the pore-forming material are important for the extrusion molding and for controlling the porosity of the honeycomb unit. The pore-forming material may be increased or decreased according to a desired porosity. The disperse medium is not particularly limited, but water, an organic solvent (such as toluene), alcohol (such as methanol), and the like can be used. The forming aid is not particularly limited, but ethylene glycol, dextrin, fatty acid soap, polyalcohol, and the like can be used.

The raw material paste is not particularly limited, but preferably formed by mixing or kneading materials. For example, a mixer and an attritor may be used to mix the materials, or a kneader may be used to sufficiently knead the substances. The method to shape the raw material paste is not particularly limited. For example, it is preferable to shape the raw material paste by extrusion molding or the like in a shape with predetermined cell density or opening ratio. At this time, the honeycomb unit molded body is shaped considering shrinkage caused in subsequent drying and firing steps.

Next, the honeycomb unit molded body is dried. A drying apparatus to dry the honeycomb unit is not particularly limited, but a microwave drying apparatus, a hot air drying apparatus, a dielectric drying apparatus, a decompression drying apparatus, a vacuum drying apparatus, a freeze drying apparatus, and the like can be used. The dried body is preferably degreased. Conditions of the degreasing are not particularly limited, but it is preferable to degrease the honeycomb unit molded body at about 400° C. for about two hours though depending on the kind and amount of the organic material included in the molded body. Further, the dried and degreased honeycomb unit molded body is fired. Conditions to fire the honeycomb unit molded body are not particularly limited, but the temperature is preferably about 600° C. to about 1200° C., or more preferably about 600° C. to about 1000° C. With the firing temperature of equal to or higher than about 600° C., sintering of the honeycomb unit is facilitated, therefore, it becomes easier to obtain a strength as the honeycomb unit. With the firing temperature of equal to or lower than about 1200° C., zeolite crystals are not easily broken and the sintering does not proceed too much. Thus, it becomes easier to manufacture a porous honeycomb unit with an appropriate porosity.

(Honeycomb Structure)

The honeycomb structure of the embodiment of the present invention includes one or plural honeycomb units. In the honeycomb structure including plural honeycomb units, the honeycomb units are stacked and arranged so that the through holes of the cells in each honeycomb unit are aligned in the same direction. FIGS. 1A and 1B are perspective views showing examples of the honeycomb structure of the embodiment of the present invention. In the honeycomb structure 1 shown in FIG. 1A, the plural honeycomb units 2 are bonded to each other with the adhesive 5 and arranged together. Each honeycomb unit 2 is formed so that the cells 3 are aligned in parallel to each other in the longitudinal direction. The honeycomb structure 1 shown in FIG. 1B is formed of one honeycomb unit 2. In this manner, the honeycomb structure 1 may be formed of one or plural honeycomb units 2. A side surface (a surface in parallel to the longitudinal direction of the cells, hereinafter simply called a side surface) of the honeycomb structure 1 is preferably covered with the coating material layer 6 to keep the strength of the honeycomb structure 1.

The honeycomb structure 1 shown in FIGS. 1A and 1B has the cross-section in a circular shape, however, the honeycomb structure of the embodiment of the present invention may have the cross-section in a square shape, a rectangular shape, a hexagonal shape, a sector shape, and the like. The exterior of the honeycomb structure may be cut if necessary. The cross-section of the honeycomb structure may be determined depending on the kind of usage, but it is preferable that the cross-sectional area is the same along the longitudinal direction.

(Manufacture of Honeycomb Structure)

First, a manufacturing method of a honeycomb structure formed of plural honeycomb units as shown in FIG. 1A is described. An adhesive is applied to a side surface (a surface that is not the cross-section) of the honeycomb units and the honeycomb units are sequentially bonded. A body of the bonded honeycomb units is dried and solidified to form a honeycomb unit bonded body in a predetermined size. A side surface of the honeycomb unit bonded body is cut to be formed in a desired shape.

The adhesive is not particularly limited, but an inorganic binder in which an inorganic particle is mixed, an inorganic binder in which an inorganic fiber is mixed, an inorganic binder in which an inorganic particle and an inorganic fiber are mixed, and the like can be used. Further, an organic binder may be added to these adhesives. The organic binder is not particularly limited, but one or more organic binders selected from polyvinyl alcohol, methyl cellulose, ethyl cellulose, carboxymethyl cellulose, and the like is suggested.

It is preferable that a layer of the adhesive to bond the plural honeycomb units have a thickness of about 0.5 mm to about 2 mm. The number of honeycomb units to be bonded may be appropriately determined in accordance with the size of the honeycomb structure. The honeycomb unit bonded body formed by bonding the honeycomb units with the adhesive may be appropriately cut or polished corresponding to the shape of the honeycomb structure.

A coating material is applied to an exterior (side surface) of the honeycomb structure, where the through-holes are not open, and dried and solidified to form a coating material layer. Since the exterior of the honeycomb structure is protected in this manner, the strength of the honeycomb structure can be enhanced. The coating material is not particularly limited, but the same material as the adhesive or a different material than the adhesive may be used. The coating material may have the same or different blending ratio as the adhesive. The thickness of the coating material layer is not particularly limited, but preferably about 0.1 mm to about 2 mm. The coating material layer may not be formed if unnecessary.

After bonding the plural honeycomb units with the adhesive, the honeycomb unit bonded body preferably undergoes a heating process. When the coating material layer is provided, the honeycomb unit bonded body is preferably degreased after forming the adhesive material layer and the coating material layer. When an organic binder is included in the adhesive material layer and the coating material layer due to the degreasing, the organic binder can be degreased to be removed. Conditions of the degreasing may be determined depending on the kind and amount of the included organic matter, but the degreasing is preferably performed at about 700° C. for about two hours.

As an example of a honeycomb structure of the embodiment of the present invention, FIG. 1A shows a schematic view of the honeycomb structure 1 formed by bonding plural rectangular solid honeycomb units 2 having a cross-section, which is vertical to the longitudinal direction of the through-holes, in a square shape, and cutting the outline of the honeycomb unit bonded body in a cyrindrical shape. After that, the coating material layer 6 is formed over this honeycomb structure 1. The honeycomb units 2 may be formed with a predetermined cross-section shape of, for example, a sector shape or a square shape and bonded to each other to form a honeycomb structure in a predetermined shape to omit cutting and polishing steps.

A manufacturing method of a honeycomb structure formed of one honeycomb unit as shown in FIG. 1B is described below. The honeycomb structure shown in FIG. 1B can be manufactured similarly to the honeycomb structure shown in FIG. 1A except in that only one honeycomb unit is used. The honeycomb unit is formed in a cyrindrical shape by cutting, polishing, and the like as required, a coating material layer formed of the same adhesive as the honeycomb structure shown in FIG. 1A is formed over the exterior of the honeycomb unit, and the honeycomb unit is degreased, similarly to the manufacturing method of the honeycomb structure formed of the plural honeycomb units. In this manner, the honeycomb unit formed of one honeycomb unit as shown in FIG. 1B can be manufactured.

### EXAMPLES

Hereinafter, examples of a honeycomb structure manufactured with various conditions are described, however, the present invention is not limited to these examples.

### Example 1

### Manufacture of Honeycomb Unit

Fe zeolite particles (3 mass % of Fe ion-exchanged β-type zeolite, a silica/alumina ratio of 40, a specific surface area of 110 m²/g, and an average particle diameter of 2 μm (the average particle diameter is an average particle diameter of a secondary particle, the same applies hereinafter)), an alumina composition (alumina sol with a solid concentration of 20 mass %) other than alumina included in zeolite and an alumina fiber, and an alumina fiber (an average fiber diameter of 6 μm and an average fiber length of 100 μm) were mixed at a ratio of 66.7 mass %, 13.3 mass %, and 20 mass % respectively. 10 parts by weight of methyl cellulose was added as organic binder to 100 parts by total weight of the Fe zeolite particles, the alumina composition, and the alumina fiber and mixed. Further, a plasticizer, a surfactant, and a lubricant were added at small amounts to the mixture. By mixing and kneading the mixture by controlling the viscosity with water, a composition to be molded was obtained. Next, this composition was extruded by an extruder, thereby a raw molded honeycomb body was obtained.

The raw molded honeycomb body was then sufficiently dried by using a microwave drying apparatus and a hot air drying apparatus and degreased at 400° C. for two hours. After that, the molded honeycomb body was fired at 700° C. for two hours, thereby a honeycomb unit in a cyrindrical shape having cells in a quadrangle (square) shape was formed (cross-section of 35 mm×35 mm×length 150 mm) with a wall thickness (thickness of a cell wall) of 0.25 mm, a cell density of 62 cells/cm², an opening ratio of 64%, and a zeolite content of 250 g/L per apparent unit volume of the honeycomb unit. The porosity of the cell wall was measured by a mercury porosimeter. The Fe ion-exchanged zeolite was formed by impregnating zeolite particles in a ferric nitrate ammonium solution to exchange Fe ions. The amount of exchanged Fe ions was obtained by an IPC light emission analysis using an ICPS-8100 (manufactured by SHIMADZU CORPORATION).

Table 1 shows compositions (mass %) of the Fe zeolite particles, the alumina composition, and the alumina fiber as raw materials used for manufacturing the honeycomb unit, a thickness of a wall, a cell density, and an opening ratio of the honeycomb unit.

TABLE 1

| | | | | Cell structure | | | | Evaluation | | |
|---|---|---|---|---|---|---|---|---|---|---|
| | Composition (mass %) | | | Cell | Cell | Opening | | Converting | Bending | |
| | Fe | | Alumina | wall | density | ratio | (y | ratio | strength | Pressure |
| | zeolite | Alumina | fiber | (mm) | (cells/cm²) | (%) | value) | (%) | (Mpa) | loss |
| Example 1 | 66.7 | 13.3 | 20 | 0.25 | 62 | 64 | 66.1 | 91 | 2.1 | Good |
| Example 2 | 66.7 | 13.3 | 20 | 0.20 | 85 | 66 | 66.1 | 86 | 1.7 | Good |
| Example 3 | 66.7 | 13.3 | 20 | 0.28 | 78 | 57 | 66.1 | 96 | 3.1 | Good |
| Example 4 | 64 | 16 | 20 | 0.20 | 116 | 61 | 65.2 | 92 | 2.4 | Good |
| Example 5 | 64 | 16 | 20 | 0.25 | 58 | 65 | 65.2 | 83 | 1.8 | Good |
| Example 6 | 64 | 16 | 20 | 0.28 | 78 | 57 | 65.2 | 95 | 3.0 | Good |
| Example 7 | 61 | 19 | 20 | 0.28 | 78 | 57 | 63.6 | 94 | 3.2 | Good |
| Example 8 | 61 | 19 | 20 | 0.30 | 47 | 63 | 63.6 | 81 | 2.4 | Good |
| Example 9 | 70 | 10 | 20 | 0.28 | 78 | 57 | 65.3 | 98 | 2.7 | Good |
| Example 10 | 70 | 10 | 20 | 0.20 | 93 | 65 | 65.3 | 93 | 1.6 | Good |
| Comparative Example 1 | 66.7 | 13.3 | 20 | 0.25 | 47 | 68 | 66.1 | 79 | 1.3 | Good |
| Comparative Example 2 | 66.7 | 13.3 | 20 | 0.25 | 116 | 53 | 66.1 | 97 | 3.5 | Bad |
| Comparative Example 3 | 64 | 16 | 20 | 0.20 | 78 | 67 | 65.2 | 75 | 1.4 | Good |
| Comparative Example 4 | 61 | 19 | 20 | 0.25 | 58 | 65 | 63.6 | 74 | 2.0 | Good |
| Comparative Example 5 | 70 | 10 | 20 | 0.20 | 85 | 66 | 65.3 | 93 | 1.0 | Good |
| Comparative Example 6 | 72 | 8 | 20 | 0.28 | 78 | 57 | 69.6 | 98 | 1.1 | Good |

### Manufacture of Honeycomb Structure)

An adhesive in a paste form was applied over a side surface of the manufactured honeycomb unit to form an adhesive material layer with a thickness of 1 mm. The adhesive layer was then dried and solidified at 120° C. Then, four stages and four rows of the honeycomb units were bonded to each other to form a honeycomb unit bonded body in an approximate rectangular solid shape. The adhesive material paste was formed by mixing 29 mass % of alumina particles (an average particle diameter of 2 μm), 7 mass % of alumina fibers (an average fiber diameter of 6 μm and an average fiber length of 100 μm), 34 mass % of alumina sol (20 mass % of solid concentration), 5 mass % of carboxymethyl cellulose, and 25 mass % of water. A side wall of the honeycomb unit bonded body was cut into a cylindrical shape by using a diamond cutter. The adhesive paste was applied as a coating material with a thickness of 0.5 mm over the exterior of a side wall of the honeycomb unit bonded body in the cylindrical shape, thereby a columnar honeycomb unit bonded body in the same shape as the honeycomb structure shown in FIG. 1A was manufactured. The cylindrical honeycomb unit bonded body was dried and solidified at 120° C. and held at 700° C. for two hours to degrease the adhesive material layer and the coating material. In this manner, a honeycomb structure in a cylindrical shape (with a diameter of about 144 mm×length of 150 mm) was manufactured.

### Examples 2 to 10, Comparative Examples 1 to 6

Honeycomb units and honeycomb structures of Examples 2 to 10 and Comparative Examples 1 to 6 were manufactured similarly to Example 1 except that the compositions (mass %) of the Fe zeolite particle, alumina composition, and alumina fiber in Example 1 were changed as shown in Table 1 and the die (mold) of the extruder was changed. Table 1 shows compositions (mass %) of the Fe zeolite particles, the alumina composition, and the alumina fiber as raw materials, a thickness of a wall, a cell density, and an opening ratio of the honeycomb units of Examples 2 to 10 and Comparative Examples 1 to 6.

### Performance Evaluation of Honeycomb Structures

A NOx converting rate of an exhaust gas, a bending strength, and a pressure loss caused when flowing the exhaust gas in the honeycomb structure manufactured in Examples 1 to 10 and Comparative Examples 1 to 6 were measured as follows and results are shown in Table 1.

### NOx Converting Rate

Crylindrical honeycomb portions with a diameter of 30 mm and a length of 50 mm were cut out of the honeycomb units of Examples 1 to 10 and Comparative Examples 1 to 6, to be used as evaluation samples. The evaluation samples were heated at 700° C. for 48 hours so as to simulate aging. Then, with the evaluation samples kept at 250° C., a simulation gas of a vehicle exhaust gas with a composition as shown in Table 2 heated at 250° C. was introduced at SV35000/hr. A reduction ratio (%) of an NO composition in the simulation gas after using the evaluation sample is shown as the NOx converting ratio (%).

TABLE 2

| Gas | Composition |
|---|---|
| N₂ | Balance |
| CO₂ | 5 vol % |
| O₂ | 14 vol % |
| NO | 350 ppm |
| NH₃ | 350 ppm |
| H₂O | 5 vol % |
| SV | 35000/hr |

### Bending Strength

The bending strength of each honeycomb unit was measured according to the three-point bending test method JIS-R160. Specifically, a testing system 5582 manufactured by Instron Corporation was used to apply a breaking load W in a vertical direction to the honeycomb unit with a span L of 135 mm and a crosshead speed of 1 mm/min. After calculating a cross-section secondary moment Z by subtracting a moment of hollows in the cells, a bending strength σ was calculated by a formula (σ=WL/4Z).

The entire contents of JIS-R 1601 are incorporated herein by reference.

### Measurement of Pressure Loss of Exhaust Gas

A side surface of the cylindrical honeycomb structure (with a diameter of about 144 mm×length 150 mm) formed in each example and comparative examples was covered with an alumina mat and put into a metal case. By flowing an engine exhaust gas from one side of the case, the pressure loss was measured with an engine speed of 1500 rpm and a torque of 50 Nm for five minutes. As for the evaluation, (Good) indicates a pressure loss of 1.0 kP or less and (Bad) indicates a pressure loss of more than 1.0 kP.

### Measurement Results

The NOx converting ratio, the bending strength, and the pressure loss of an exhaust gas in Examples 1 to 10 and Comparative Examples 1 to 6 are shown in Table 1.

The NOx converting ratios of the honeycomb structures of Examples 1 to 10 were as high as 80% or more while the NOx converting ratios of the honeycomb structures of Comparative Examples 1, 3, and 4 were as low as 74 to 79%.

The bending strengths of the honeycomb units of Examples 1 to 10 were 1.5 MPa or higher while the bending strengths of the honeycomb structures of Comparative Examples 1, 3, 5, and 6 were lower than 1.5 MPa.

The pressure losses of the honeycomb structures of Examples 1 to 10 and Comparative Examples 1 and 3 to 6 were less than 1.0 kPa while the pressure loss of the honeycomb structure of Comparative Example 2 is more than 1.0 kPa. This is thought because the opening ratios of the honeycomb units in the honeycomb structures of Examples 1 to 10 and Comparative Examples 1 and 3 to 6 were about 57% or more while the aperture ratio of the honeycomb unit in the honeycomb structure of Comparative Example 2 was as small as 53%, which increased a flow resistance of the exhaust gas.

FIG. 3 shows a relationship between the content x (mass %) of zeolite and an opening ratio y (%) of the evaluation results. In FIG. 3, ∘ indicates an example and Δ indicates a comparison. Numbers attached to these marks indicate the numbers of examples and comparative examples. The content x (mass %) of zeolite and the aperture ratio y (%) of the honeycomb structures shown in Examples 1 to 10 are considered to be required to be inside a pentagon surrounded by five lines of x=61, y=57, x=70, y=0.55x+30, and y=−0.25x+82.8. Since the honeycomb structures of Examples 1 to 10 are in this area and satisfy all the three performances (NOx converting ratio, bending strength, and pressure loss), these honeycomb structures are favorable for converting a vehicle exhaust gas. However, the content x (mass %) of zeolite and the opening ratio y (%) of the honeycomb structures of Comparative Examples 1 to 6 are not in this area and do not satisfy at least one of the three performances. Therefore, these honeycomb structures are not favorable for converting a vehicle exhaust gas.

The honeycomb structure of the embodiment of the present invention is formed of a honeycomb unit with high strength and has a high NOx converting ratio, a high strength, and less pressure loss of an exhaust gas. Therefore, the honeycomb structure of the invention can be used as a catalyst for converting a vehicle exhaust gas, which is required to be small in size and lightweight. In particular, the honeycomb structure of the invention is preferably used as a NOx converting catalyst supporter for an SCR system (for example, a diesel exhaust gas converting system using ammonia).

Obviously, numerous modifications and variations of the present invention are possible in light of the above teachings. It is therefore to be understood that within the scope of the appended claims, the invention may be practiced otherwise than as specifically described herein.

What is claimed is:

1. A honeycomb structure comprising:
at least one honeycomb unit comprising:
plural cell walls extending from one end face to another end face in a longitudinal direction of the honeycomb structure to define plural cells;
about 61 mass % to about 70 mass % of zeolite;
about 15 mass % to about 25 mass % of an inorganic fiber; and
about 10 mass % to about 20 mass % of alumina other than alumina included in the zeolite and the inorganic fiber,
wherein the at least one honeycomb unit has an opening ratio (%) of about 57% or more,
wherein the opening ratio is equal to or less than y shown in a following formula (1) when a content x (mass %) of the zeolite included in the at least one honeycomb unit is less than about 66 mass %
y=0.55x+30 (1), and
wherein the opening ratio is equal to or less than y shown in a following formula (2) when the content x (mass %) of the zeolite included in the at least one honeycomb unit is about 66 mass % or more
y=−0.25x+82.8 (2).

2. The honeycomb structure as claimed in claim 1, wherein a porosity of the cell walls is about 25% to about 40%.

3. The honeycomb structure as claimed in claim 1, wherein a cell density of the at least one honeycomb unit is about 39 cells/cm² to about 124 cells/cm².

4. The honeycomb structure as claimed in claim 1, wherein a contained amount of the zeolite per apparent unit volume of the at least one honeycomb unit is about 230 g/L or more.

5. The honeycomb structure as claimed in claim 1, wherein the zeolite includes at least one of β-type zeolite, Y-type zeolite, ferrierite, ZSM-5-type zeolite, mordenite, faujasite, zeolite A, and zeolite L.

6. The honeycomb structure as claimed in claim 1, wherein the zeolite has a mole ratio of silica to alumina (silica/alumina ratio) of about 30 to about 50.

7. The honeycomb structure as claimed in claim 1, wherein the zeolite includes an exchanged ion of at least one of Fe, Cu, Ni, Co, Zn, Mn, Ti, Ag, and V.

8. The honeycomb structure as claimed in claim 1, wherein the zeolite includes an exchanged ion of Fe.

9. The honeycomb structure as claimed in claim 1, wherein the inorganic fiber includes at least one of an alumina fiber, a silica fiber, a silicon carbide fiber, a silica alumina fiber, a glass fiber, a potassium titanate fiber, and an aluminum borate fiber.

10. The honeycomb structure as claimed in claim 1, wherein the alumina is derived from alumina sol.

11. The honeycomb structure as claimed in claim 1, wherein the at least one honeycomb unit comprises a plurality of honeycomb units that are bonded to each other via an adhesive provided between the plurality of honeycomb units.

12. The honeycomb structure as claimed in claim 1, wherein a side surface of the honeycomb structure is coated with a coating material layer.

13. The honeycomb structure as claimed in claim 1, wherein a content of the zeolite per apparent unit volume in the at least one honeycomb unit is equal to or less than about 270 g/L.

14. The honeycomb structure as claimed in claim 1, wherein a content of the zeolite per apparent unit volume of the at least one honeycomb unit is about 245 g/L to about 270 g/L.

15. The honeycomb structure as claimed in claim 1, wherein a thickness of the cell walls is about 0.15 mm to about 0.35 mm.

16. The honeycomb structure as claimed in claim 1, wherein the zeolite has secondary particles.

17. The honeycomb structure as claimed in claim 16, wherein the secondary particles have an average particle diameter of about 0.5 μm to about 10 μm.

18. The honeycomb structure as claimed in claim 1, wherein an aspect ratio of the inorganic fiber is about 2 to about 1000.

19. The honeycomb structure as claimed in claim 1, wherein the at least one honeycomb unit includes an inorganic binder.

20. The honeycomb structure as claimed in claim 19, wherein the inorganic binder comprises alumina sol.

21. The honeycomb structure as claimed in claim 19, wherein the inorganic binder comprises at least one of inorganic sol and a clay binder.

22. The honeycomb structure as claimed in claim 21, wherein the inorganic binder comprises one of silica sol, titania sol, sepiolite sol, attapulgite sol, liquid glass, white clay, kaolin, montmorillonite, sepiolite, and attapulgite.

23. The honeycomb structure as claimed in claim 1, wherein the at least one honeycomb unit includes alumina particles.

24. The honeycomb structure as claimed in claim 1, wherein the at least one honeycomb unit includes inorganic particles other than alumina particles and zeolite particles.

25. The honeycomb structure as claimed in claim 24, wherein the inorganic particles other than the alumina particles and the zeolite particles comprise at least one of silica, zirconia, titania, ceria, mullite, and these precursors.

26. The honeycomb structure as claimed in claim 24, wherein the inorganic particles other than the zeolite have secondary particles with an average particle diameter equal to or smaller than an average particle diameter of secondary particles of the zeolite.

27. The honeycomb structure as claimed in claim 24, wherein an average particle diameter of the inorganic particles is about 1/10 to about 1/1 of an average particle diameter of the zeolite.

28. The honeycomb structure as claimed in claim 1, wherein the cell walls have a catalytic component.

29. The honeycomb structure as claimed in claim 28, wherein the catalytic component comprises at least one of a noble metal, an alkali metal compound, and an alkali earth metal compound.

30. The honeycomb structure as claimed in claim 1, wherein the at least one honeycomb unit comprises a single honeycomb unit.

31. The honeycomb structure as claimed in claim 1, wherein the honeycomb structure is so constructed that an exterior of the honeycomb structure is cut.

32. The honeycomb structure as claimed in claim 11, wherein the adhesive is dried and solidified.

33. The honeycomb structure as claimed in claim 12, wherein the coating material layer is dried and solidified.

34. The honeycomb structure as claimed in claim 11, wherein the at least one honeycomb unit comprises a plurality of honeycomb units that are bonded to each other to form the honeycomb structure having a predetermined shape.

35. The honeycomb structure as claimed in claim 1, wherein the honeycomb structure is so constructed to be used as a NOx converting catalyst supporter for a selective catalytic reduction system.
